(19) United States
(12) Patent Application Publication
(10) Pub. No.: US 2023/0005112 A1
(43) Pub. Date: Jan. 5, 2023

(54) IMAGE MATCHING METHOD

(71) Applicant: V5 TECHNOLOGIES CO., LTD., Hsinchu City (TW)

(72) Inventors: Sheng-Chih HSU, Hsinchu City (TW); Chien-Ting CHEN, Hsinchu City (TW)

(21) Appl. No.: 17/363,761

(22) Filed: Jun. 30, 2021

(51) Int. Cl. G06T 5/50; G06T 7/90; G06T 5/40

(52) U.S. Cl. CPC G06T 5/50; G06T 7/90; G06T 5/40; G06T 2207/20224

(57) ABSTRACT

A image matching method includes: converting an original image and a reference image to a hue-based color space; adjusting hue values of the original image based on hue values of the reference image to obtain an adjusted image; generating a hue-difference image based on the adjusted image and the original image; obtaining a binary image based on the hue-difference image; and for each pixel having a non-zero pixel value in the binary image, determining whether an adjacent pixel has a pixel value equal to zero, and in the affirmative, correcting a hue value corresponding to the pixel in the adjusted image based on the hue values corresponding to the adjacent pixel in the original image and in the adjusted image.

### FIELD

The disclosure relates to an image matching method, and more particularly to an image matching method in a color space that is represented by hue.

### BACKGROUND

Conventionally, to match colors of an original image to colors of a reference image, histogram matching is performed on RGB (red, green, blue) color channels of the original image based on RGB color channels of the reference image, respectively. Although such approach makes each of the RGB color channels of the original image have a histogram similar to that of the corresponding one of the RGB color channels of the reference image, color distortion may occur since a color mixing ratio of each color in the original image may be changed after histogram matching is performed. Meanwhile, image feature(s) of the original image may be lost as a consequence.

### SUMMARY

Therefore, an object of the disclosure is to provide an image matching method for matching colors of an original image to colors of a reference image that can alleviate at least one of the drawbacks of the prior art.

According to the disclosure, the image matching method includes steps of:

converting the original image and the reference image to a color space that is represented by hue;

adjusting hue values of all pixels of the original image based on hue values of pixels of the reference image so as to obtain an adjusted image having a plurality of pixels corresponding respectively to the pixels of the original image;

generating a hue-difference image based on hue values of the pixels of the adjusted image and the hue values of the pixels of the original image, the hue-difference image having a plurality of pixels corresponding to the pixels of the adjusted image, respectively;

for each of the pixels of the hue-difference image, setting a pixel value of the pixel to one when the pixel value is greater than the predetermined threshold, and setting the pixel value of the pixel to zero when the pixel value is not greater than the predetermined threshold, so as to obtain a binary image that has a plurality of pixels corresponding to the pixels of the hue-difference image, respectively; and

for each pixel having a non-zero pixel value in the binary image,
determining whether at least one adjacent pixel that is adjacent to the pixel has a pixel value equal to zero, and
when it is determined that at least one adjacent pixel has a pixel value equal to zero, correcting a hue value of a corresponding one of the pixels of the adjusted image that corresponds to the pixel of the binary image based on the hue value of each of at least one of the pixels of the original image and the hue value of each of at least one of the pixels of the adjusted image, wherein the at least one of the pixels of the original image and the at least one of the pixels of the adjusted image correspond to the at least one adjacent pixel of the binary image.

### BRIEF DESCRIPTION OF THE DRAWINGS

Other features and advantages of the disclosure will become apparent in the following detailed description of the embodiment with reference to the accompanying drawings, of which:

FIG. 1 is a block diagram illustrating an example of a computing device configured to implement an image matching method according to an embodiment of the disclosure; and

FIGS. 2 to 5 cooperatively illustrate a flowchart of an image matching method according to an embodiment of the disclosure.

### DETAILED DESCRIPTION

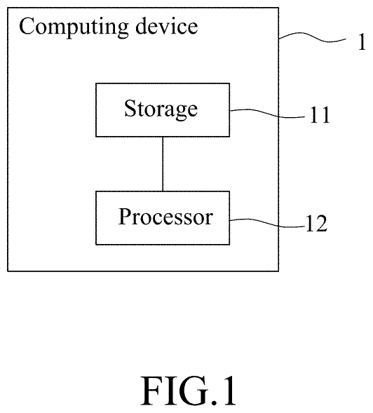

Referring to FIG. 1, an embodiment of a computing device 1 is illustrated. The computing device 1 is configured to implement an image matching method for matching colors of an original image to colors of a reference image according to an embodiment of the disclosure. The computing device 1 may be embodied using a computing server, a personal computer, a desktop computer, a laptop computer, a notebook computer, a tablet computer or a smartphone, but is not limited to what are disclosed herein and may vary in other embodiments.

The computing device 1 includes a storage 11 and a processor 12 that are electrically connected to each other.

The storage 11 is configured to store the reference image. The storage 11 may be embodied using flash memory, a hard disk drive (HDD) or a solid state disk (SSD), electrically-erasable programmable read-only memory (EEPROM) or any other non-volatile memory devices, but is not limited thereto.

The processor 12 may include, but not limited to, a central processing unit (CPU), a microprocessor, a micro control unit (MCU), a system on a chip (SoC), or any circuit that is configurable or programmable in a software manner and/or a hardware manner to implement functionalities discussed in this disclosure.

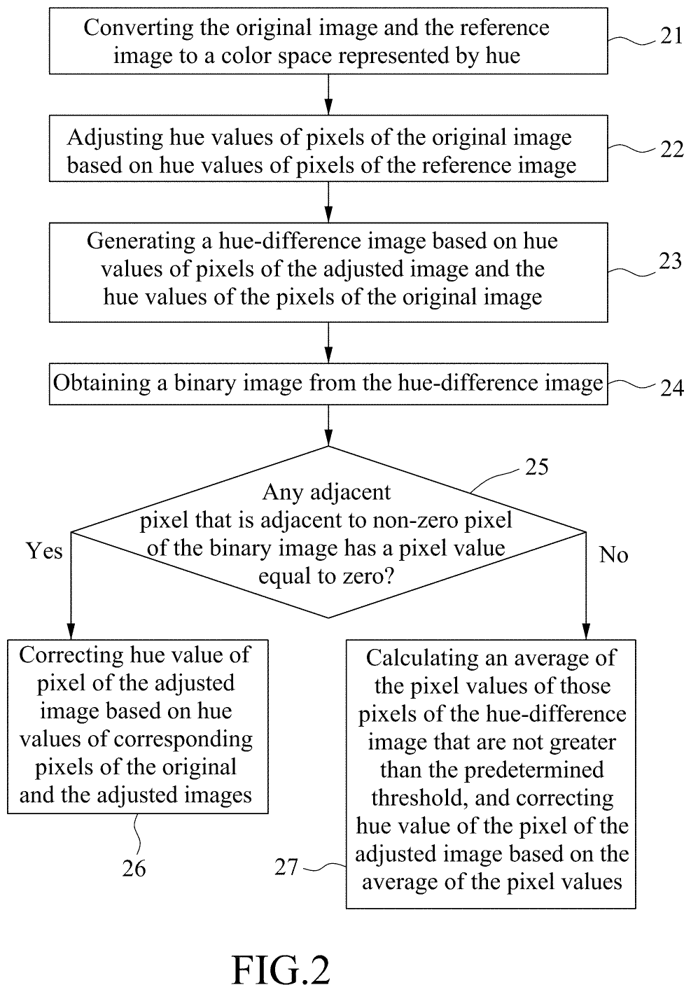

FIGS. 2 to 5 illustrate an embodiment of the image matching method. The image matching method includes a hue adjustment procedure and a brightness adjustment procedure. It is worth to note that the brightness adjustment procedure is optional and can be omitted according to needs in practice.

Referring to FIGS. 1 and 2, the hue adjustment procedure includes steps 21 to 27 delineated below.

In step 21, the processor 12 converts the original image and the reference image to a color space that is represented by hue. In this embodiment, the color space is a hue, saturation, value (HSV) color space. However, in other embodiments, the color space may be a hue, saturation, intensity (HSI) color space, or any hue-based color space.

In step 22, the processor 12 adjusts hue values of all pixels of the original image based on hue values of pixels of the reference image so as to obtain an adjusted image. The adjusted image has a plurality of pixels corresponding respectively to the pixels of the original image.

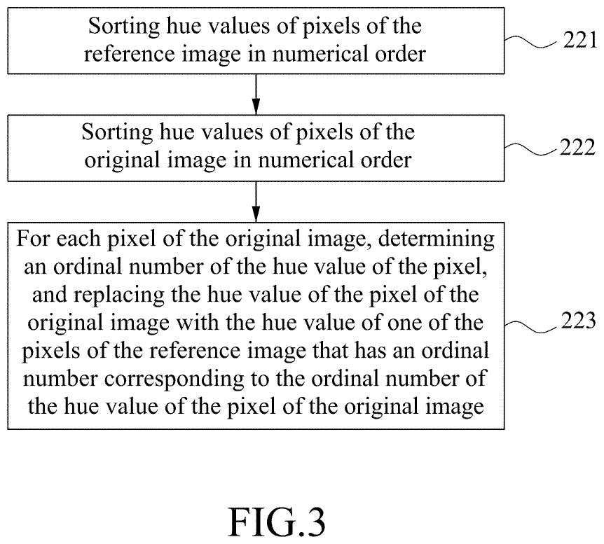

Specifically speaking, referring to FIG. 3, step 22 includes sub-steps 221 to 223 delineated below.

In sub-step 221, the processor 12 sorts the hue values of the pixels of the reference image in numerical order. In this embodiment, the hue values of the pixels of the reference image are sorted in ascending order; that is, the hue values of the pixels of the reference image are arranged in order from smallest to largest.

In sub-step 222, the processor 12 sorts the hue values of the pixels of the original image in numerical order. Similarly, the hue values of the pixels of the original image are also sorted in ascending order.

In sub-step 223, with respect to each pixel of the original image, the processor 12 determines an ordinal number of the hue value of the pixel, and replaces the hue value of the pixel of the original image with the hue value of one of the pixels of the reference image that has an ordinal number corresponding to the ordinal number of the hue value of the pixel of the original image, so as to obtain the adjusted image. In some embodiments, the hue value of the pixel of the original image is replaced by the hue value of the pixel of the reference image that has the same ordinal number as the hue value of the pixel of the original image. It should be noted that when the original image has plural pixels, of which the hue values are identical and which are sorted to have different ordinal numbers, the processor 12 uses the smallest one of the ordinal numbers of the identical hue values to select the hue value in the reference image that is sorted to have an ordinal number equal to the smallest one of the ordinal numbers of the identical hue values in the original image, and replaces the identical hue values in the original image with the hue value in the reference image thus selected. For example, in a scenario where the original image has three pixels, of which the hue values are all equal to 15 and which are sorted to have different ordinal numbers 30^{th}, 31^{st} and 32^{rd}, respectively, the processor 12 uses the smallest one of the ordinal numbers (i.e., 30^{th}, hereinafter also referred to as the designated ordinal number) to select the hue value of one of the pixels of the reference image that has the designated ordinal number (i.e., 30^{th}). Thereafter, the processor 15 replaces the identical hue values (i.e., 15) of the three pixels of the original image with the hue value thus selected.

In step 23, the processor 12 generates a hue-difference image based on hue values of the pixels of the adjusted image and the hue values of the pixels of the original image. The hue-difference image has a plurality of pixels corresponding to the pixels of the adjusted image, respectively. Specifically, for each pixel of the adjusted image and the corresponding one of the pixels of the original image, the processor 12 calculates an absolute value of a difference between the hue value of the pixel of the adjusted image and the hue value of the corresponding one of the pixels of the original image, and makes the absolute value serve as the pixel value of the pixel of the hue-difference image that corresponds to the pixel of the adjusted image.

In step 24, for each of the pixels of the hue-difference image, the processor 12 sets a pixel value of the pixel to one when the pixel value is greater than a predetermined threshold, and sets the pixel value of the pixel to zero when the pixel value is not greater than the predetermined threshold, so as to obtain a binary image. The binary image has a plurality of pixels corresponding to the pixels of the hue-difference image, respectively. In particular, the predetermined threshold is equal to a sum of an average of the pixel values of the pixels of the hue-difference image and a standard deviation of the pixel values of the pixels of the hue-difference image. In one embodiment, the average of the pixel values and the standard deviation of the pixel values are each calculated with respect to all pixels of the hue-difference image. In one embodiment, the average of the pixel values and the standard deviation of the pixel values are each calculated with respect to pixel(s) of the hue-difference image that has a non-zero pixel value.

In step 25, with respect to each pixel having a non-zero pixel value in the binary image, the processor 12 determines whether at least one adjacent pixel that is adjacent to the pixel has a pixel value equal to zero. When it is determined that at least one adjacent pixel has a pixel value equal to zero, a flow of procedure of the image matching method proceeds to step 26. On the other hand, when it is determined that no adjacent pixel has a pixel value equal to zero, the flow proceeds to step 27. It is worth to note that for a pixel that is not located at a boundary of the binary image, the pixel would have a total of eight adjacent pixels that are directly connected to and adjacent to the pixel. For a pixel that is located at the boundary of the binary image and is located at a corner, the pixel would have a total of three adjacent pixels that are directly connected to and adjacent to the pixel. For a pixel that is located at the boundary of the binary image and is located at an edge rather than a corner, the pixel would have a total of five adjacent pixels that are directly connected to and adjacent to the pixel. Specifically, in step 25, for each pixel of the binary image that has a non-zero pixel value, the flow goes to step 26 when it is determined that any one of the adjacent pixels has a pixel value equal to zero, and goes to step 27 when it is determined that each of the adjacent pixels has a pixel value not equal to zero.

In step 26, for each pixel of the binary image having a non-zero pixel value and having at least one adjacent pixel with a pixel value equal to zero, the processor 12 corrects a hue value of a corresponding one of the pixels of the adjusted image that corresponds to the pixel of the binary image based on the hue value of each of at least one of the pixels of the original image and the hue value of each of at least one of the pixels of the adjusted image, wherein the at least one of the pixels of the original image and the at least one of the pixels of the adjusted image correspond to the at least one adjacent pixel of the binary image that has the pixel value equal to zero. More specifically, in step 26, for each pixel of the binary image that has a non-zero pixel value and that has the at least one adjacent pixel having a pixel value of zero, the processor 12 calculates a sum of an average of the hue value(s) of the at least one of the pixels of the original image that corresponds to the at least one adjacent pixel of the binary image and the hue value of the corresponding one of pixels of the adjusted image that corresponds to the pixel of the binary image. Then, the processor 12 subtracts, from the sum thus calculated, an average of the hue value(s) of the at least one of the pixels of the adjusted image that corresponds to the at least one adjacent pixel of the binary image, so as to obtain the hue value of the corresponding one of the pixels of the adjusted image that corresponds to the pixel of the binary image.

In step 27, for each pixel of the binary image having a non-zero pixel value and having each adjacent pixel with a pixel value not equal to zero, the processor 12 calculates an average of the pixel values of those of the pixels of the hue-difference image that are not greater than the predetermined threshold, and corrects the hue value of the corresponding one of the pixels of the adjusted image that corresponds to the pixel of the binary image based on the average of the pixel values of those of the pixels of the hue-difference image that are not greater than the predetermined threshold.

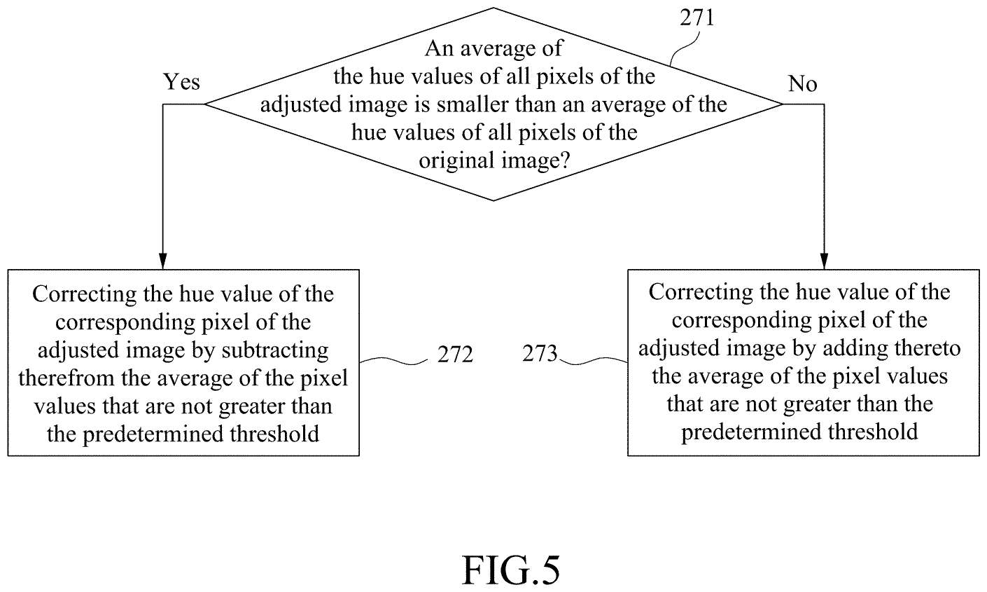

Specifically speaking, referring to FIG. 5, correcting the hue value in step 27 includes sub-steps 271 to 273 delineated below.

In sub-step 271, the processor 12 determines whether an average of the hue values of all pixels of the adjusted image is smaller than an average of the hue values of all pixels of the original image. When it is determined that the average of the hue values of all pixels of the adjusted image is smaller than the average of the hue values of all pixels of the original image, the flow proceeds to sub-step 272. Otherwise, when it is determined that the average of the hue values of all pixels of the adjusted image is not smaller than the average of the hue values of all pixels of the original image, the flow proceeds to sub-step 273.

In sub-step 272, for each pixel of the binary image having a non-zero pixel value and having each adjacent pixel with a pixel value not equal to zero, the processor 12 corrects the hue value of the corresponding one of the pixels of the adjusted image that corresponds to the pixel of the binary image by subtracting therefrom the average of the pixel values of those of the pixels of the hue-difference image that are not greater than the predetermined threshold.

In sub-step 273, for each pixel of the binary image having a non-zero pixel value and having each adjacent pixel with a pixel value not equal to zero, the processor 12 corrects the hue value of the corresponding one of the pixels of the adjusted image that corresponds to the pixel of the binary image by adding thereto the average of the pixel values of those of the pixels of the hue-difference image that are not greater than the predetermined threshold.

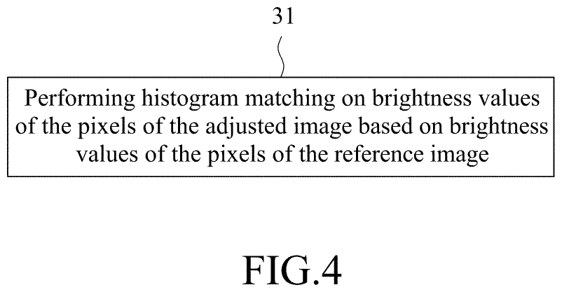

After performance of the hue adjustment procedure, the brightness adjustment procedure is performed on the adjusted image. Referring to FIG. 4, the brightness adjustment procedure includes step 31 delineated below.

In step 31, the processor 12 performs histogram matching on brightness values of the pixels of the adjusted image based on brightness values of the pixels of the reference image. In this way, brightness of the adjusted image would be made similar to that of the reference image.

It is worth to note that the image matching method according to the disclosure may be applied to inspect products for defect detection. In particular, two pictures of the same object taken under different conditions (e.g., different ambient light) may have different colors, and such color difference may be misleading and may cause an incorrect result of defect detection. The image matching method according to the disclosure can reduce the aforesaid color difference, and thus misjudgment due to color difference may be alleviated and accuracy of defect detection may be enhanced. It should be noted that application of the image matching method is not limited to the disclosure herein, and the image matching method may be used in any field where color adjustment is involved.

In summary, the image matching method according to the disclosure utilizes the computing device 1 to convert the original image and the reference image to the color space that is represented by hue, and to adjust the hue values of the pixels of the original image based on the hue values of the pixels of the reference image so as to obtain the adjusted image. In this way, the issue of color distortion, which may occur when RGB (red, green, blue) color channels of the original image are separately adjusted, may be avoided. Moreover, the image matching method according to the disclosure utilizes the computing device 1 to correct the hue value(s) of specifically conditioned pixel (s) in the adjusted image so as to alleviate abnormally large variations of hue values in the adjusted image, which may otherwise cause image distortion. Further, histogram matching is performed on the brightness values of the pixels of the adjusted image based on the brightness values of the pixels of the reference image, so as to make brightness of the adjusted image similar to that of the reference image.

In the description above, for the purposes of explanation, numerous specific details have been set forth in order to provide a thorough understanding of the embodiment. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. An image matching method for matching colors of an original image to colors of a reference image, the image matching method comprising steps of:
converting the original image and the reference image to a color space that is represented by hue;
adjusting hue values of all pixels of the original image based on hue values of pixels of the reference image so as to obtain an adjusted image having a plurality of pixels corresponding respectively to the pixels of the original image;
generating a hue-difference image based on hue value s of the pixels of the adjusted image and the hue values of the pixels of the original image, the hue-difference image having a plurality of pixels corresponding to the pixels of the adjusted image, respectively;
for each of the pixels of the hue-difference image, setting a pixel value of the pixel to one when the pixel value is greater than a predetermined threshold, and setting the pixel value of the pixel to zero when the pixel value is not greater than the predetermined threshold, so as to obtain a binary image that has a plurality of pixels corresponding to the pixels of the hue-difference image, respectively; and
for each pixel having a non-zero pixel value in the binary image,
determining whether at least one adjacent pixel that is adjacent to the pixel has a pixel value equal to zero, and
when it is determined that at least one adjacent pixel has a pixel value equal to zero, correcting a hue value of a corresponding one of the pixels of the adjusted image that corresponds to the pixel of the binary image based on the hue value of each of at least one of the pixels of the original image and the hue value of each of at least one of the pixels of the adjusted image, wherein the at least one of the pixels of the original image and the at least one of the pixels of the adjusted image correspond to the at least one adjacent pixel of the binary image.

2. The image matching method as claimed in claim 1, wherein the step of adjusting hue values of all pixels of the original image includes:
sorting the hue values of the pixels of the reference image in numerical order;
sorting the hue values of the pixels of the original image in numerical order; and
with respect to each pixel of the original image, determining an ordinal number of the hue value of the pixel, and replacing the hue value of the pixel of the original image with the hue value of one of the pixels of the reference image that has an ordinal number corresponding to the ordinal number of the hue value of the pixel of the original image, so as to obtain the adjusted image.

3. The image matching method as claimed in claim 1, wherein the step of generating a hue-difference image includes:
with respect to each pixel of the adjusted image and the corresponding one of the pixels of the original image, calculating an absolute value of a difference between the hue value of the pixel of the adjusted image and the hue value of the corresponding one of the pixels of the original image, and making the absolute value serve as the pixel value of the pixel of the hue-difference image that corresponds to the pixel of the adjusted image.

4. The image matching method as claimed in claim 1, wherein the predetermined threshold is equal to a sum of an average of pixel values of the pixels of the hue-difference image and a standard deviation of the pixel values of the pixels of the hue-difference image.

5. The image matching method as claimed in claim 1, wherein the step of correcting a hue value includes, for each pixel of the binary image that has a non-zero pixel value and that has at least one adjacent pixel having a pixel value of zero:
calculating a sum of an average of the hue value (s) of the at least one of the pixels of the original image that corresponds to the at least one adjacent pixel of the binary image and the hue value of the corresponding one of the pixels of the adjusted image that corresponds to the pixel of the binary image; and
subtracting, from the sum thus calculated, an average of the hue value(s) of the at least one of the pixels of the adjusted image that corresponds to the at least one adjacent pixel of the binary image, so as to obtain the hue value of the corresponding one of the pixels of the adjusted image that corresponds to the pixel of the binary image.

6. The image matching method as claimed in claim 1, further comprising steps of:
for each pixel having a non-zero pixel value in the binary image, when it is determined that the adjacent pixel has a pixel value not equal to zero,
calculating an average of the pixel values of those of the pixels of the hue-difference image that are not greater than the predetermined threshold, and
correcting the hue value of the corresponding one of the pixels of the adjusted image that corresponds to the pixel of the binary image based on the average of the pixel values of those of the pixels of the hue-difference image that are not greater than the predetermined threshold.

7. The image matching method as claimed in claim 6, wherein the step of correcting the hue value includes:
determining whether an average of the hue values of all pixels of the adjusted image is smaller than an average of the hue values of all pixels of the original image;
when it is determined that the average of the hue values of all pixels of the adjusted image is smaller than the average of the hue values of all pixels of the original image, correcting the hue value of the corresponding one of pixels of the adjusted image that corresponds to the pixel of the binary image by subtracting therefrom the average of the pixel values that are not greater than the predetermined threshold; and
when it is determined that the average of the hue values of all pixels of the adjusted image is not smaller than the average of the hue values of all pixels of the original image, correcting the hue value of the corresponding one of pixels of the adjusted image that corresponds to the pixel of the binary image by adding thereto the average of the pixel values of those of the pixels of the hue-difference image that are not greater than the predetermined threshold.

8. The image matching method as claimed in claim 6, wherein the color space is a hue, saturation, value (HSV) color space.

9. The image matching method as claimed in claim 8, subsequent to the step of correcting the hue value, further comprising:
performing histogram matching on brightness values of the pixels of the adjusted image based on brightness values of the pixels of the reference image.
